(19) United States
(12) Patent Application Publication
(10) Pub. No.: US 2002/0184944 A1
(43) Pub. Date: Dec. 12, 2002

(54) Wind direction apparatus

(76) Inventor: Brian Brannigan, Lisburn (IE)

Correspondence Address: Ronald E. Greigg, Unit One, 1423 Powhatan Street, Alexandria, VA, 22314, US

(21) Appl. No.: 09/877,080

(22) Filed: Jun. 11, 2001

(51) Int. Cl. G01W 1/00

(52) U.S. Cl. 73/170.05

(57) ABSTRACT

A wind direction apparatus is provided adjacent to a landing strip. The apparatus includes a first device (2) and a second device (4). The first device (2) has a visible first area (6) and is fixed and acts as a datum position. The second device (4) has a visible second area (8) of similar dimensions to the first area (6) and is movable towards and away from the first area (6) responsive to wind direction and wind intensity whereby the disposition of the second area relative to the first indicates wind direction and wind intensity.

This invention relates to an apparatus to indicate wind direction and speed, for general aviation and other uses, and is an alternative to the use of a windsock to indicate to pilots of aircraft the wind direction and speed.

Pilots need a clear indication of wind direction and speed in order to prepare for take-off and particularly their landing circuit. Windsocks have a disadvantage in that at about 900 ft altitude and above when a pilot needs an indication, a windsock is not sufficiently discernible to give the pilot a clear indication of wind direction and speed and can give an ambiguous indication when viewed from certain angles.

An object of the present invention is to obviate or mitigate this disadvantage.

Accordingly, the present invention is a wind direction apparatus to be provided adjacent to a landing strip, the apparatus including a first device and a second device, the first device having visible first area and being fixed and acting as a datum position and the second device having a visible second area of similar dimensions to the first area and being movable towards and away from the first area responsive to wind direction and wind intensity whereby the disposition of the second area relative to the first area indicates wind direction and wind intensity.

Preferably, the first device is a pillar at least part of which is tubular and co-axial with an inner post about which it is capable of low-friction rotational movement, the pillar mounting a first secondary indicator and a wind vane, the indicator comprising an indicating device serving as the first area on said pillar with rotational movement of the pillar being responsive to any wind moving the wind vane. The second device is preferably a masking device serving as the second area and being biased to partially or wholly overlie and mask the indicating device, the masking device being movable against its biasing in response to wind to unmask the indicating device. At least the top surface of the indicating device and at least the surface of the masking device facing upwards both desirably being contrastingly different from each other and from the surrounding environs. The indicating device is beneficially a substantially horizontally oriented plate.

Preferably also, the wind vane is mounted at the distal end of a support cantilevered from the pillar near to its bottom end. The support preferably includes an outwardly inclined arm and a substantially horizontal tie. A counterweight is desirably provided on the pillar oppositely to the tie to give balanced rotational movement.

Preferably also, the pillar is ground-securable with the inner post mounted on a base unit. An outer tubular portion of the pillar is preferably secured to the top of the post to prevent unintentional separation. The base unit desirably incorporates a socket for the bottom end of the pillar and a levelling mechanism.

Preferably also, the masking device is a light-weight ball surmounted on an upright arm pivoted near to its lower end with weight biasing provided below the pivot. The ball of the device preferably is located above the plate with the upright arm movable along a track or slot. The track or slot is beneficially provided with a buffer at its outer end to limit movement of the upright arm to within the track or slot. The ball and/or upright arm may be cranked over the plate. Alternatively, the ball may be replaced by a plate arrangement.

Preferably further, on the side of the ball or plate arrangement opposite to the indicating device i.e. on the down-wind side, an area of a contrasting colour to the rest of the ball or plate arrangement is provided and visible only when the wind is blowing towards the observer.

Embodiments of the present invention will now be described, by way of example, with reference to the accompanying diagrammatic drawings, in which:

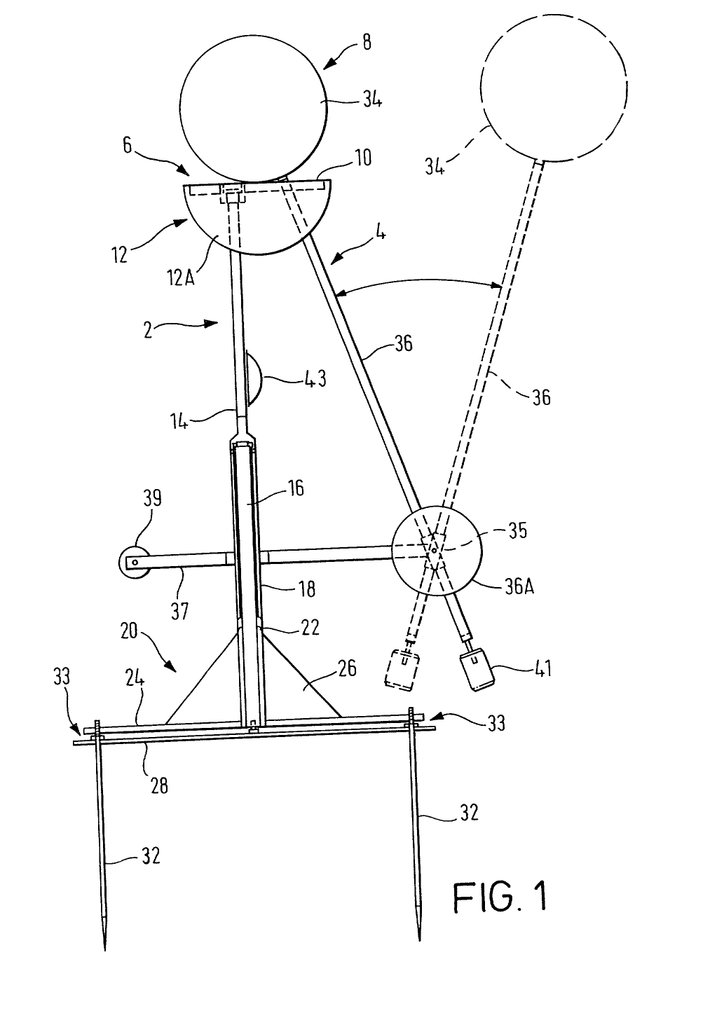

FIG. 1 is a front view of a wind direction apparatus according to a first embodiment of the present invention;

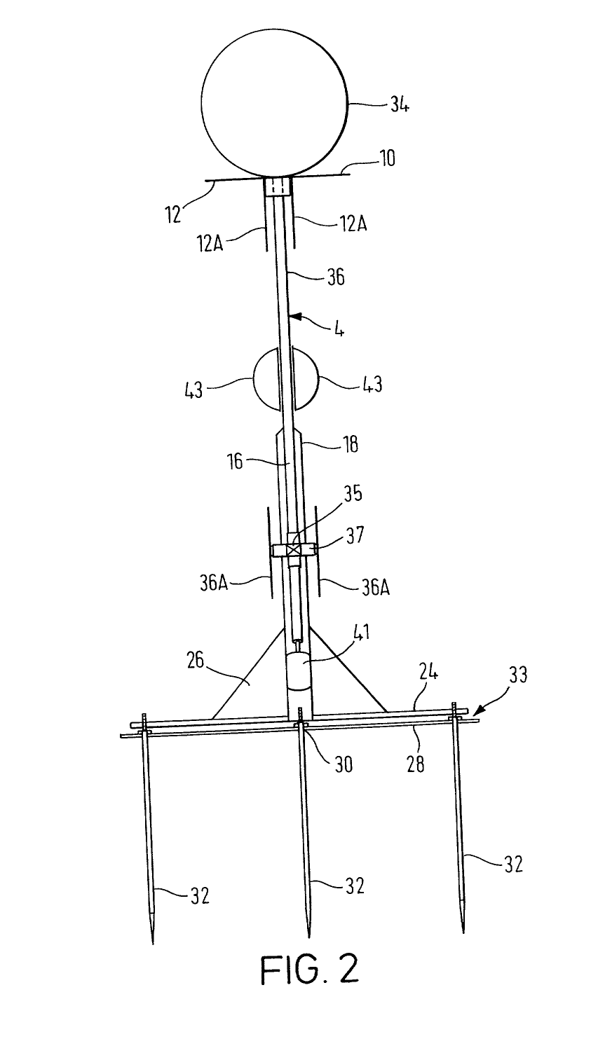

FIG. 2 is a side view in the direction of ‘A’ of the apparatus as shown in FIG. 1;

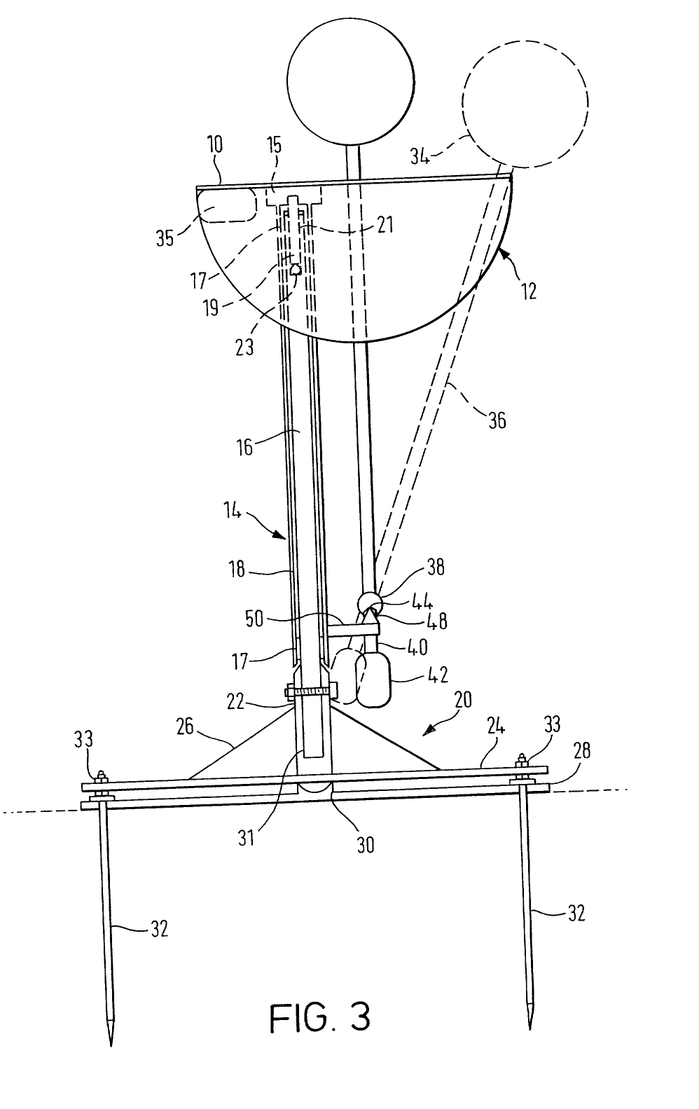

FIG. 3 is a front view of a wind direction apparatus according to a second embodiment;

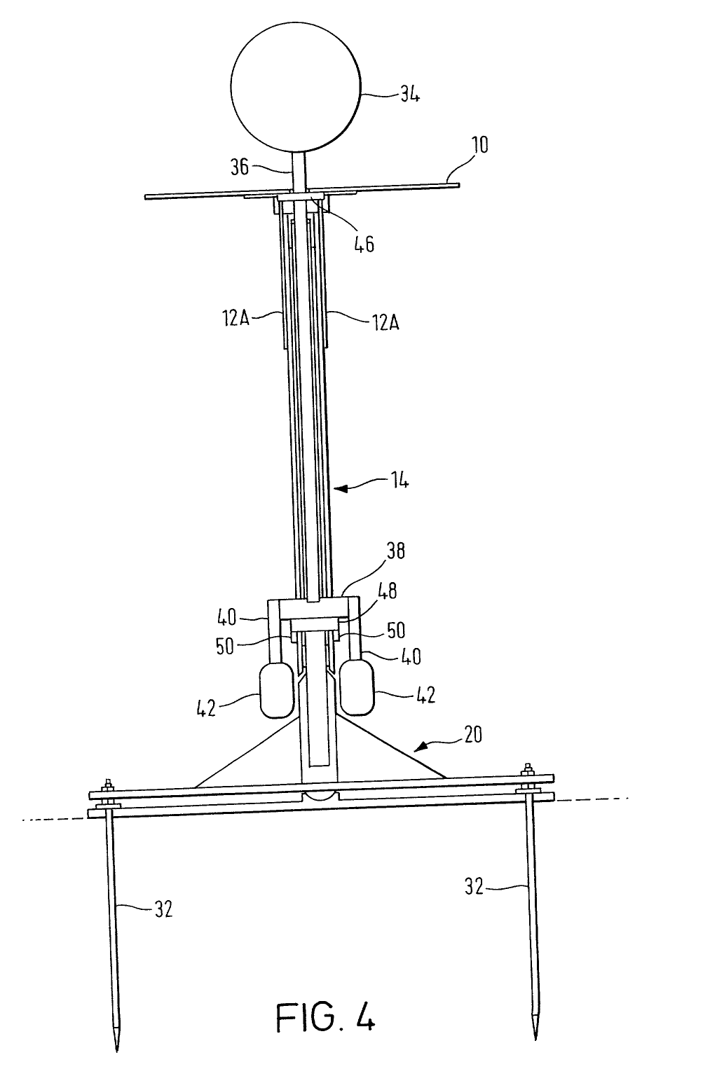

FIG. 4 is a side view in the direction of ‘B’ of the apparatus as shown in FIG. 3;

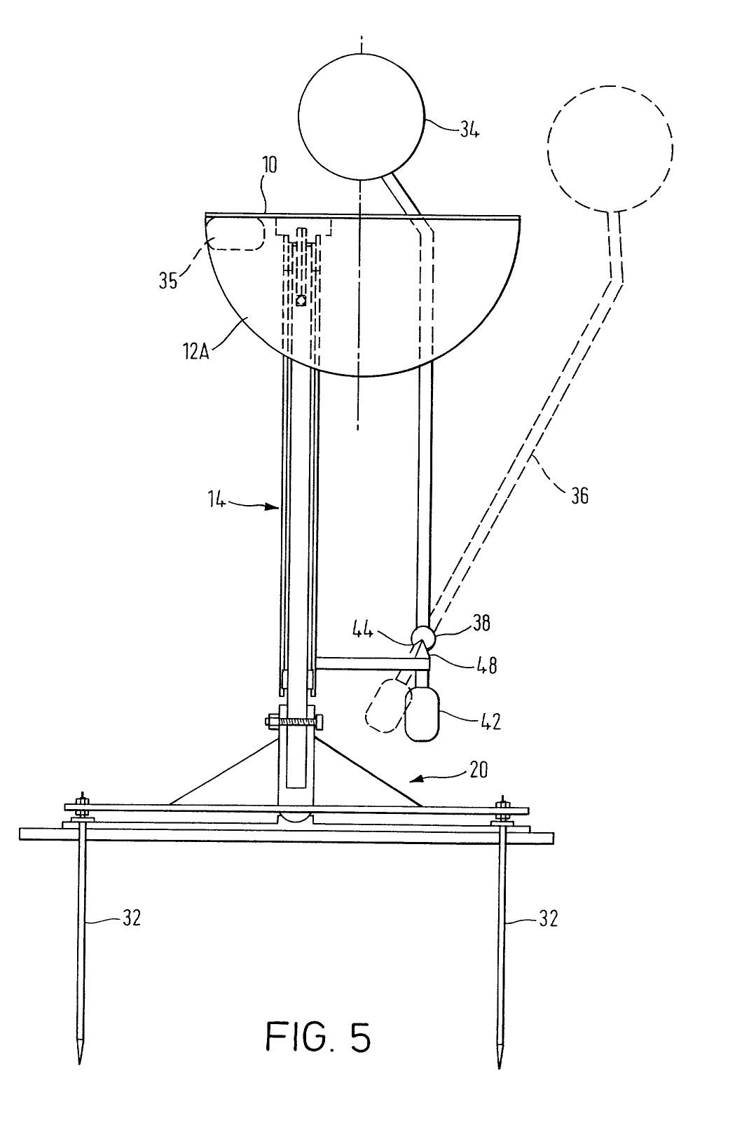

FIG. 5 is a front view of a modified apparatus of the second embodiment;

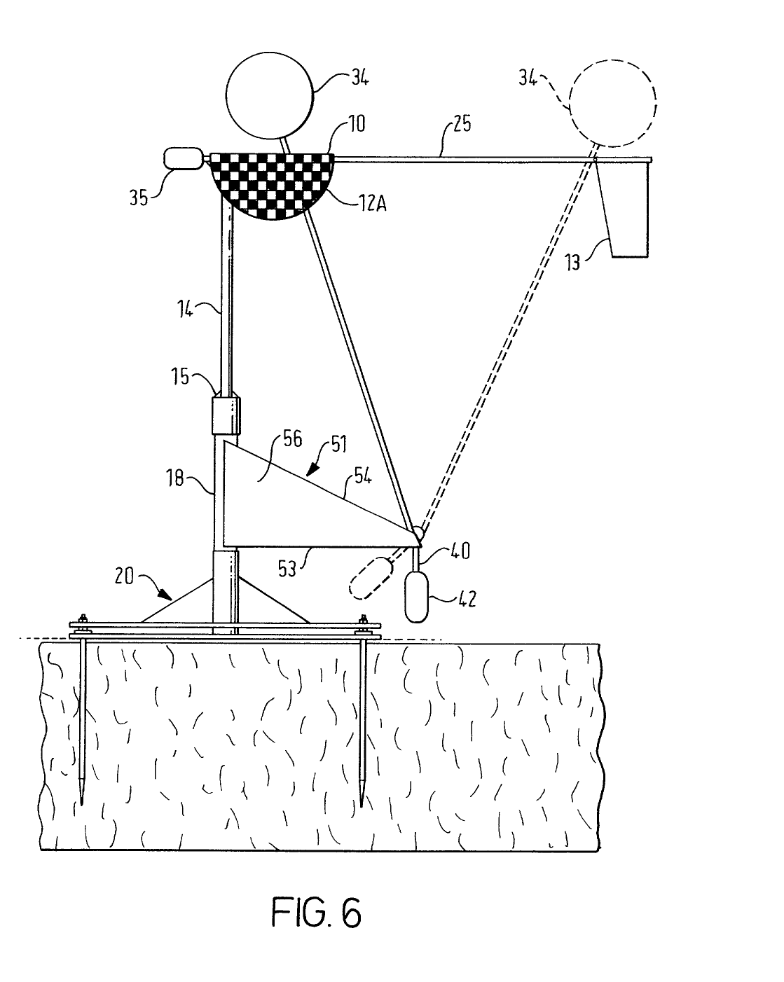

FIG. 6 is a front view of a third embodiment of the apparatus;

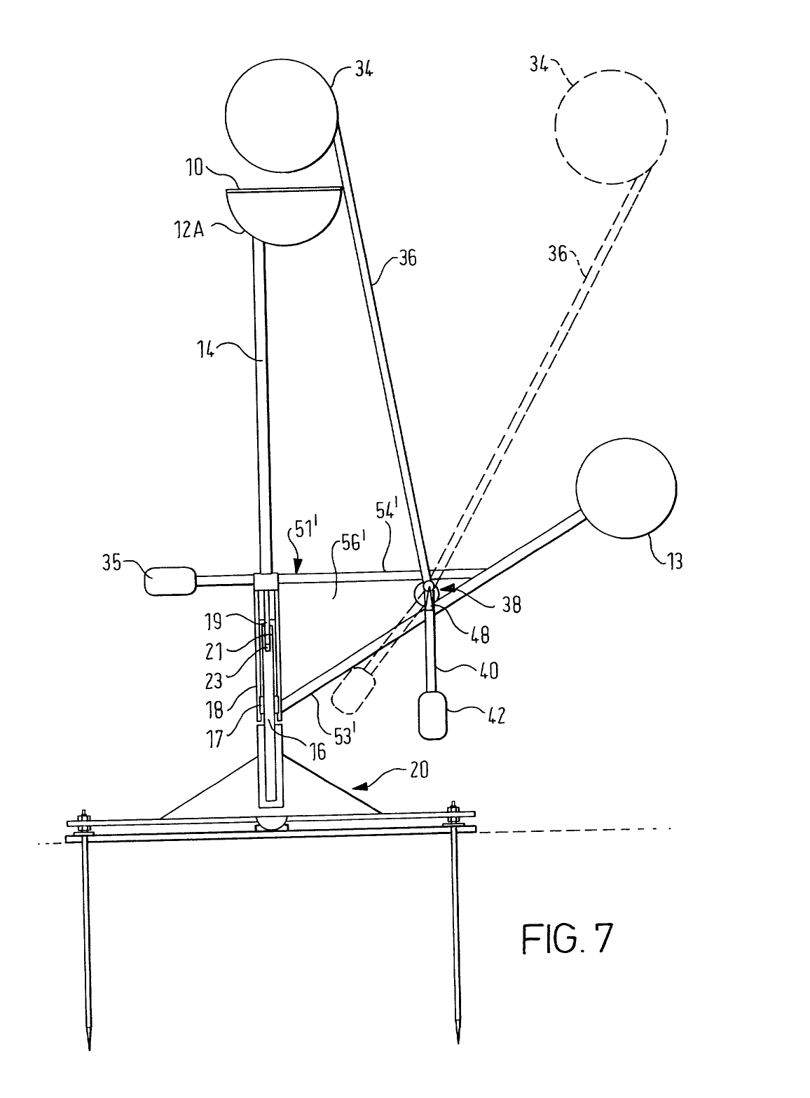

FIG. 7 is a front view of a fourth embodiment of the apparatus; and

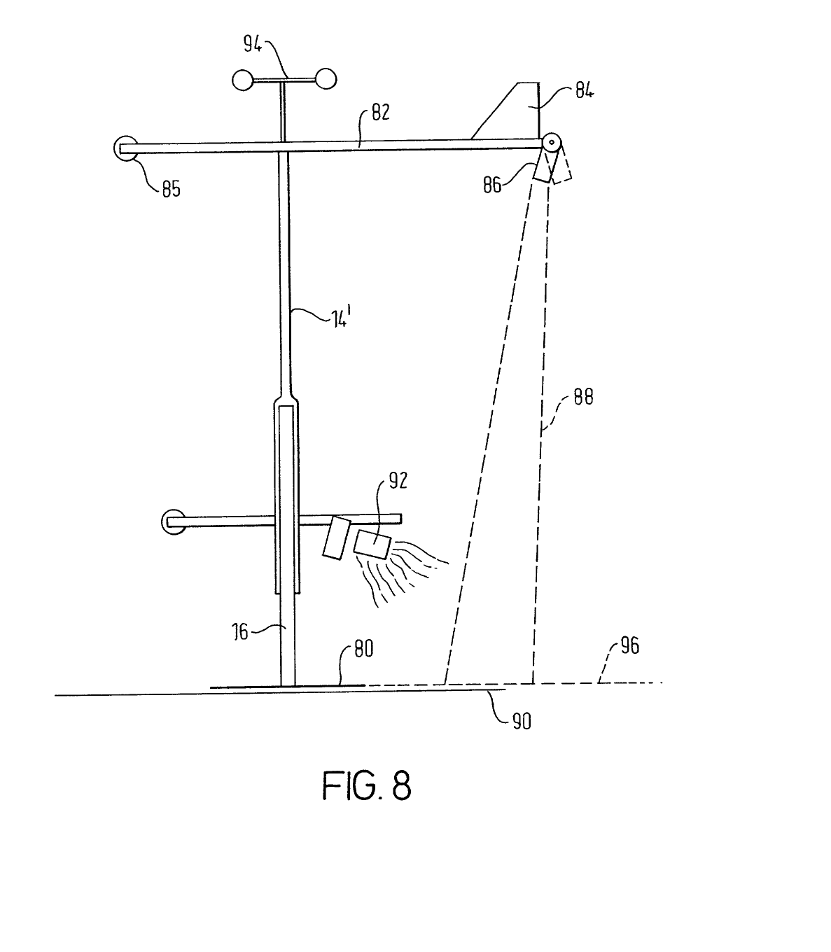

FIG. 8 is a front view of a fifth embodiment of the apparatus.

Referring to the drawings in general to all embodiments, a wind direction apparatus is erected adjacent to a landing strip. The apparatus includes a first device 2 and a second device 4. The first device 2 has a visible first area 6 which is fixed and acts as a datum position. The second device 4 has a visible second area 8 of similar shape and dimensions to the first area 6 and is movable towards and away from the first area 6 responsive to wind direction and wind intensity. Disposition of the second area 8 relative to the first area 6 indicates wind direction and winds intensity. The first device 2 comprises a pillar 14 at least part of which is tubular and co-axial with an inner post 16 about which it is capable of low-friction rotational movement. The pillar 14 mounts a first secondary indicator 12. The indicator consists of an indicating device serving as the first area 6 on said pillar 14 with rotational movement of the pillar 14 being responsive to any wind moving the wind vane. The indicating device is a substantially horizontally oriented plate 10 mounted on top of the pillar 14. A masking device serving as the second area 8 is biased to partially or wholly overlie and mask the plate 10. The masking device is movable against its biasing in response to wind to unmask the plate 10. The colour and/or pattern of the top surface of the plate 10 and the upper surface of the masking device are both contrastingly different from each other and from the surrounding environs.

The pillar 14 is ground-securable with the inner post 16 mounted in a base unit 20. An outer tubular portion 18 of the pillar 14 is secured to the top of the post 16 to prevent separation. The tubular portion 18 is spaced from the post 16 by bearings 17 at the top and bottom of the tubular portion 18. The unit 20 incorporates a socket 22 provided upstanding from a first base plate 24, the socket 22 being for positioning of the bottom end of the inner post 16. The socket 22 is supported by a series of gusset webs 26 between itself and the base plate 24. A levelling mechanism is provided comprising a second base plate 28 to underlie the first base plate 24 and centrally of which a cup 30 is provided into which a complementarily shaped bulbous extension 33 of the post 16 locates. The base plates 24, 28 are securable to the ground by pins 32 and are adjustably attitudinally, spaced from each other to effect levelling by the tops of the pins 32 being screw-threaded and nut arrangements 33 provided thereon as shown.

The masking device is a light weight ball 34 surmounted on an upright arm 36 pivoted near to its lower end with weight biasing provided below the pivot. The ball 34 of the masking device is located above the plate 10 with the upright arm 36 movable in and along a slot.

In a first embodiment as shown in FIGS. 1 and 2, the pillar 14 has a tubular bottom half which fits co-axially over a post 16 of corresponding height. The post 16 is secured in the socket 22. The first secondary indicator 12 comprises two similar substantially semi-circular plates 12A uprightly oriented and secured to the plate 10. The plate 10 and plates 12A are mounted radially offset of the pillar 14 and between its two plates 12A has a straight slot into and out of which the upright arm 36 of the masking device moves against or under its biasing. The upright arm 36 is pivoted at 35 between two bars 37 and therebelow has a counter-balancing weight 41. The bars 37 are mounted on the tubular portion 18 and extends therebeyond a determined distance, and between the ends of the bars a counter-weight 39 is secured. A second secondary indicator 43 is mounted to extend radially or tangentially from the pillar 14 above the post 16. The indicator 43 is two segmental plates at acute angles one to another as shown in FIGS. 1 and 2. The colour of the obverse side of the plates shown in FIG. 2 is the same as the colour of the ball 34, the colour of the reverse side being the same of the other non-coloured components. The wind vane 36A comprises two circular plates provided as shown one on each side of the pivot.

In a second embodiment as shown in FIGS. 3 to 5, in which like parts are denoted by like numerals, the pillar 14 is completely tubular and the post extends co-axially up the full length of the pillar 14. A cap 15 closes off the tubular portion 18 below plate 10. The post 16 is bolted to the socket 22 as shown in FIGS. 3 and 5. An axially downwardly-extending spindle 19 fits into the top of the tubular portion 18 with the spindle 19 seating in a blind bore 21 in the post 16, a ball-bearing 23 being positioned in the bore 21 at its inner end and on which the spindle 19 rotates. The indicator 12 comprises two similar substantially semi-circular plates 12A uprightly oriented and secured to opposite sides of the tubular portion 18 and to the underside of the plate 10. The plate 10 and plates 12A are mounted radially offset of the pillar 14 as shown in FIGS. 1 and 3. The plate 10 from its securement to the pillar 14 and indicator 12 between its two plates 12A have the straight track, and the upright arm of the masking device is mounted for movement along the track. The slot or elongate straight track is provided with a buffer 46 at each of its opposite ends to limit movement of the upright arm 36 to within the length of the slot. A weight 35 is secured to the underside of the plate 10 diametrically in line with the track and located on the opposite side of the securement. The upright arm 36 has near to its lower end a cross-piece 38 provided with two bifurcated arms 40 both carrying similar weights 42 to provide the biasing. The cross-piece 38 has an inverted channel 44 therealong on its lower side. The arm 36 is supported on a bar 48 of triangular formation carried by two similar supporting arms 50 secured to opposite positions on the portion 18 with the bar 48 being spaced by the supporting arms 50 from the tubular portion 18, the inverted channel 44 of the cross-piece 38 of the upright arm 36 resting on the upper edge of the bar 48 and pivotally movable thereon.

In a modification of the second embodiment as shown in FIG. 5, the upright arm 36 may be cranked over the plate 10 as shown.

In a third embodiment as shown in FIG. 6 and in which like parts are denoted by like numerals, the pillar 14 has a tubular portion 18 along about one third to one half of its length extending from its lower edge. The pillar 14 extends up through the cap 15 at the top of the tubular portion 18. In this embodiment, the plates 12A are much smaller than those in the second embodiment and a pair of elongate rods 25 extend from one side of the plates 12A and at their distal ends mount a second, and in this embodiment main, wind vane 13. The rods 25 project a short distance from the opposite side of the plates 12A and carry the weight 35 to counterbalance the load on their opposite end. The slot extends through the rods 25 and part of plates 12A. The pivot of the upright arm 36 is spaced from the pillar 14 by a support 51 cantilevered from the tubular portion 18 of the pillar 14. The support 51 includes a substantially horizontal arm 53 and a downwardly sloped tie 54, the space between the arm 53 and tie 54 being enclosed by sheet 56. The sheet 56, plates 12A and second wind vane 13 all lie on the same vertical plane.

In a fourth embodiment as shown in FIG. 7 in which like parts are denoted by like numerals, the second, and in this embodiment main, wind vane 13 is mounted on an extension of the support 51′ which is cantilevered from the tubular portion 18 of the pillar 14. The support 51′ includes an outwardly inclined arm 53′ and a substantially horizontal tie 54′, the space between the arm 53′ and tie 54′ being enclosed by sheet 56′. The wind vane 13 is supported on an extension of arm 53′. On the opposite side of the pillar 14, tie 54′ is extended and carries the weight 35 to counterbalance the load of the wind vane 13. The arm 36 in this embodiment is cranked at its pivot point and the ball 34 is tangentially mounted to the upper end of arm 36.

On a side of the wind vane 13, opposite to the indicating device i.e. on the down-side, a plate (not shown) is mounted and on which a circular area of a contrasting colour or pattern to the rest of the vane 13 is provided and visible only when the wind is blowing towards the observer. The colour is the same as the colour of the ball 34.

In a first modification of all the above embodiments, the ball 34 may be replaced by a plate arrangement serving the same purpose.

In a second modification of all the above embodiments, the plate 10 may be concavely or convexly dished.

In a fifth embodiment for use at dusk and night-time, the first device 2 is a ground-engaging disc 80 from the centre of which a rotatable pillar 14′ upstands and carries at or towards its upper end an arm 82 mounted for rotatable movement thereabout. The arm 82 carries at one outer end a wind vane 84 and at the other end a counter-weight 85. A first illuminable lamp arrangement 86 is mounted at or near to the wind vane 84 and which, when illuminated, projects downwardly a beam 88 of red light onto the ground 90. At the top of the pillar 14′, an anemometer 94 is mounted to drive a small generator to produce electricity to operate a motor connected to the lamp arrangement 86 to pivot the lamp in its mountings corresponding to anemometer's rotation. Partially up the pillar 14′, a second illuminable lamp arrangement 92 is provided to direct light, when illuminated, down onto the disc 80, painted yellow, below and to shine a beam 96 of substantially white light outwardly and downwardly at an angle to form a line on the ground. The red light registers with this line and moves longitudinally along it towards and from the disc 80 under rotational movement with the anemometer 94.

This embodiment is beneficial when the first to fourth embodiments are not fully visible in the darkness.

In use, of all embodiments with the apparatus mounted on the ground and levelled adjacent to a landing strip, the indicator can be seen by pilots at 900 ft altitude and higher as the two devices are of distinct colours or colour patterns. The wind direction is indicated by an imaginary straight line drawn through the centre of the devices (FIGS. 1 to 7) or the beam of light (FIG. 8) while the wind speed is indicated by the distance between the devices. Variation in wind speed is indicated by movement of the masking device towards or away from the indicating device. When there is no wind the masking device is at rest in a position above and masking the indicating device.

To aid observers on the ground, secondary indicators 12A (coloured to match horizontal disc plate 10 and secondary indicator 43 (colour on-downwind face only—to match ball) are provided.

In FIGS. 1 to 7, the masking device moves in its track or slot responsive to any wind having first overcome the biasing of weights 42, the upright arm pivoting about the bar 48. The plate 10 with the masking device is rotated on the pillar 14 responsive to any wind. The colours and/or patterns are chosen for ease of recognition at the required altitude of not less than around 900 ft.

Variations and modifications can be made without departing from the scope of the invention described above and as claimed hereinbefore

I claim:

1. A wind direction apparatus to be provided adjacent to a landing strip including a first device and a second device, the first device having visible a first area and being fixed and acting as a datum position and the second device having a visible second area of similar dimensions to the first area and being movable towards and away from the first area responsive to wind direction and wind intensity whereby the disposition of the second area relative to the first area indicates wind direction and wind intensity.

2. A wind direction apparatus according to claim 1, wherein the first device is a pillar at least part of which is tubular and co-axial with an inner post about which it is capable of low-friction rotational movement, the pillar mounting an indicator and a wind vane, the indicator comprising an indicating device serving as the first area on said pillar with rotational movement of the pillar being responsive to any wind moving the wind vane.

3. A wind direction apparatus according to claim 1 or 2, wherein the second device is a masking device serving as the second area and being biased to partially or wholly overlie and mask the indicating device, the masking device being movable against its biasing in response to wind to unmask the indicating device.

4. A wind direction apparatus according to claim 3, wherein at least the top surface of the indicating device and at least the surface of the masking device facing upwards both are contrastingly different from each other and from the surrounding environs.

5. A wind direction apparatus according to claim 2, wherein the indicating device is a substantially horizontally oriented plate.

6. A wind direction apparatus according to claim 2, wherein the wind vane is mounted at the distal end of a support cantilevered from the pillar near to its bottom end.

7. A wind direction apparatus according to claim 6, wherein the support includes an outwardly inclined arm and a substantially horizontal tie.

8. A wind direction apparatus according to claim 7, wherein a counterweight is provided on the pillar oppositely to the tie to give balanced rotational movement.

9. A wind direction apparatus according to claim 2, wherein the pillar is ground-securable with the inner post mounted on a base unit.

10. A wind direction apparatus according to claim 9, wherein an outer tubular portion of the pillar is secured to the top of the post to prevent unintentional separation.

11 A wind direction apparatus according to claim 9, wherein the base unit incorporates a socket for a bottom end of the pillar and a levelling mechanism.

12. A wind direction apparatus according to claim 3, wherein the masking device is a light-weight ball surmounted on an upright arm pivoted near to its lower end with weight biasing provided below the pivot.

13. A wind direction apparatus according to claim 12, wherein the ball of the device is located above the plate with the upright arm movable along a track or slot.

14. A wind direction apparatus according to claim 13, wherein the track or slot is provided with a buffer at its outer end to limit movement of the upright arm to within the track or slot.

15. A wind direction apparatus according to claim 12, wherein the ball and/or upright arm are cranked over the plate.

16. A wind direction apparatus according to claim 12, wherein the ball is replaced by a plate arrangement.

17. A wind direction apparatus according to claim 16, wherein on the side of the ball or plate arrangement opposite to the indicating device i.e. on the down-wind side, an area of a contrasting colour to the rest of the ball or plate arrangement is provided and visible only when the wind is blowing towards the observer.

18. A wind direction apparatus according to claim 1, wherein the first device is a ground-engaging disc mounting a pillar carrying at or near to its upper end an arm rotatable thereon, the arm carrying at one end a fin and at the other end a counter weight, a first illuminable lamp arrangement is carried near to the fin and is directed downwards, a second illuminable lamp arrangement is mounted on the pillar to direct light onto the disc and to create a beam of light radially outwardly therefrom to form a line on the ground with which the light from the first lamp arrangement registers and is adapted to move along towards or away from the disc.

19. A wind direction apparatus according to claim 18, wherein an anemometer surmounts the pillar and is connected to the first lamp arrangement to pivot the lamp in its mountings relative to the speed of rotation of the anemometer whereby the light from the first lamp arrangement shining on the line from the second lamp arrangement moves correspondingly therealong.
